(19) United States
(12) Patent Application Publication
(10) Pub. No.: US 2005/0206120 A1
(43) Pub. Date: Sep. 22, 2005

(54) Bike handlebars adjustment

(75) Inventor: Hsueh-Sen Liao, Hsin-Chu Hsien (TW)

Correspondence Address: TROXELL LAW OFFICE PLLC, SUITE 1404, 5205 LEESBURG PIKE, FALLS CHURCH, VA, 22041, US

(73) Assignee: Hsin Lung Accessories Co., Ltd.

(21) Appl. No.: 11/023,559

(22) Filed: Dec. 29, 2004

(30) Foreign Application Priority Data
Mar. 9, 2004 (TW) 093203578

(51) Int. Cl. B62K 17/00

(52) U.S. Cl. 280/281.1; 74/551.3

(57) ABSTRACT

A means to adjust horizontal angle of a pair of handlebars of a bike; stem and fork of the bike being connected through a sleeve; a shaft holder being provided at top of the fork; a shaft being forthwith inserted to the top of the shaft holder; a sleeve inserted into the shaft being provided at the tail of the stem; the stem and the fork being pivoted to each other through the insertion of the sleeve into the shaft; a protrusion being provided on the lower edge of the sleeve; and multiple recesses being provided on a flange at the top of the shaft holder to secure the binding for assuring of precise adjustment.

### BACKGROUND OF THE INVENTION

(a) Field of the Invention

The present invention is related an adjustment between handlebars and fork of a bike, and more particularly, to one for precise adjustment of the horizontal angle of the handlebars.

(b) Description of the Prior Art

As illustrated in FIG. 1 of the accompanying drawings for a linkage between a fork 10 and a pair of handlebars 20 of the prior art of a bike, a locking head 30 and a stem 40 constitute the connection between the fork 10 and the handlebars 20. Wherein, the locking head relates to a vice structure to clamp onto the fork 10; an insertion hole is disposed at the center of the locking head 30 and a pair of pivoting ears 51 extend respectively from both sides of the locking head 30. A gap extends from where between both pivoting ears 51 to the insertion hole. One end of the stem 40 is fixed to the pair of handlebars 20; and the other end of the stem 40 is provided with a pair of clamping ears 52 to clamp to the external sides of both pivoting ears 51. A bolt 53 penetrates through where between the clamping ears 52 and the pivoting ears 51 to constitute the linkage between the stem 40 and the locking head 30 while packing the locking head 30 to securely clamp the fork 10.

When the bolt packing force by the bolt 53 is loosened up, appropriate travel can be made at where between the clamping ears 52 and the pivoting ears 51 to adjust the longitudinal angle of the handlebars 20. However, the biker tends to adjust the handlebars to such permits optimal riding status depending on the individual type of build. Therefore, the prior art appears to fail such requirements since it allows only the adjustment of the longitudinal angle of the handlebars.

### SUMMARY OF THE INVENTION

The primary purpose of the present invention is to provide a means to adjust the handlebars of a bike for achieving precise adjustment of the horizontal angle of the handlebars. To achieve the purpose, the handlebars are linked to the fork with a stem; a shaft holder is fixed to the top of the fork; a shaft is forthwith disposed at the top of the shaft holder; the tail of the stem is provided with a sleeve and the shaft is inserted into the sleeve. The shaft holder is separately provided with a flange to engage the lower edge of the sleeve by compression. At where the sleeve meets the flange, a protrusion is provided on the lower edge of the sleeve, and multiple recesses are provided on the flange of the shaft holder. A threaded suppression ring is provided at the top of the shaft to restrict the axial motion by the sleeve. Accordingly, when the suppression ring is loosened up, the sleeve is lifted to where its protrusion at the lower edge is disengaged from a recess to turn the sleeve to engage with another recess.

Alternatively, a locking knob and multiple positioning holes are respectively provided to the sleeve and the shaft; and a coil to push the locking knob toward one positioning hole is provided to the sleeve so that with the locking knob pulled out of its positioning hole the sleeve is turned to where for the locking knob to engage in another positioning hole to achieve the same purpose of achieving precise adjustment of the horizontal angle of the handlebars.

### BRIEF DESCRIPTION OF THE DRAWINGS

FIG. 1 is a schematic view showing a means of connecting handlebars and fork of a bike of the prior art.

FIG. 2 is a perspective view of a first preferred embodiment of the present invention.

FIG. 3 is an exploded view of the first preferred embodiment of the present invention.

FIG. 4 is a sectional view of the first preferred embodiment of the present invention.

FIG. 5 is a schematic view showing how the adjustment is made by the present invention.

FIG. 6 is a schematic view of the disposal of a protrusion and multiple recesses in a second preferred embodiment of the present invention.

FIG. 7 is an exploded view of a third preferred embodiment of the present invention.

FIG. 8 is a sectional view of the third preferred embodiment of the present invention.

FIG. 9 is an exploded view of a fourth preferred embodiment of the present invention.

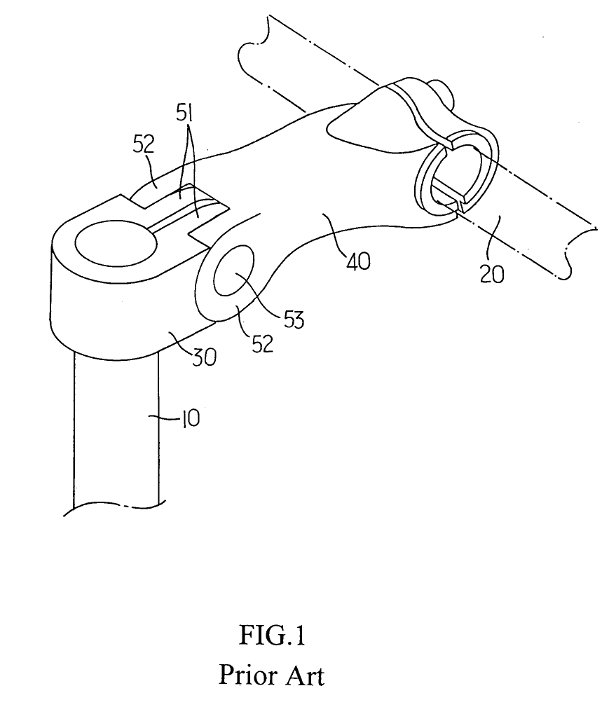

### DETAILED DESCRIPTION OF THE PREFERRED EMBODIMENTS

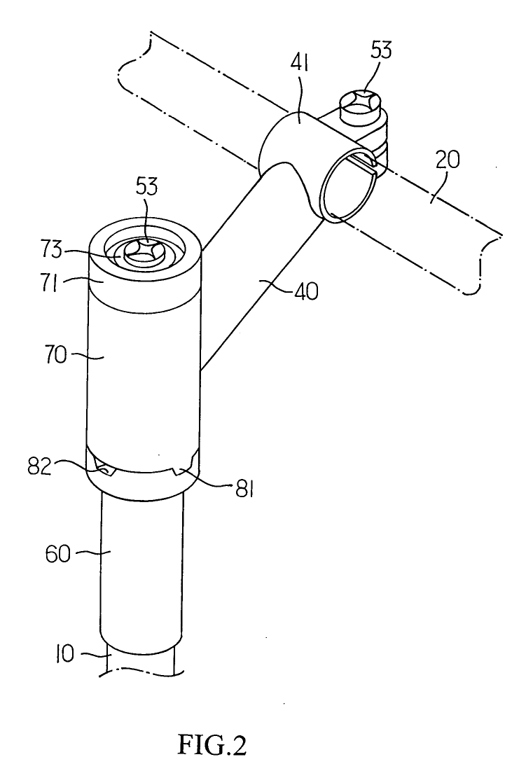

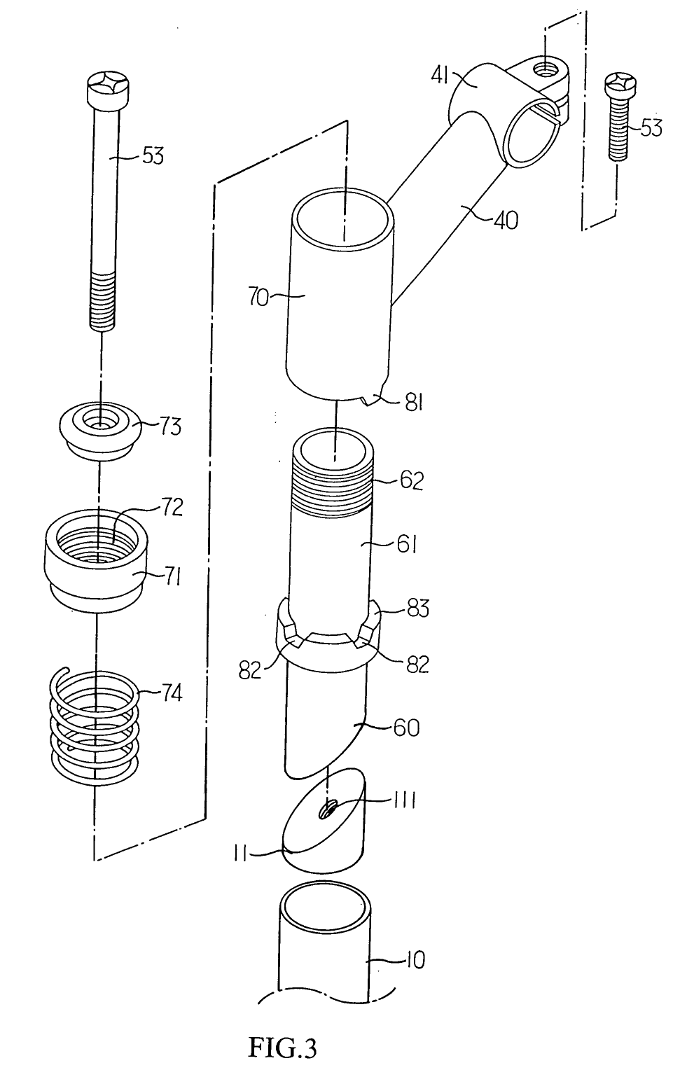

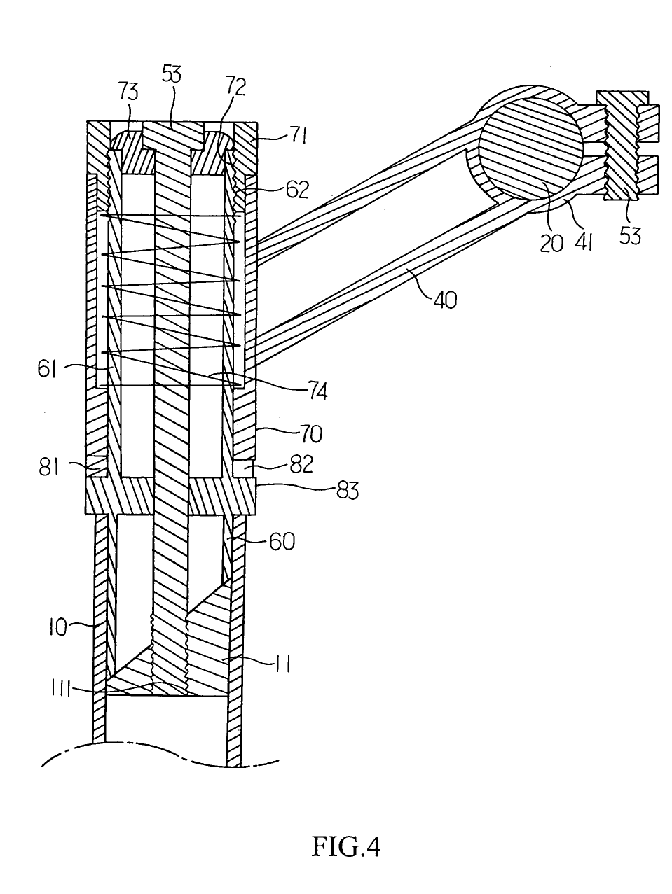

Referring to FIGS. 2 and 3, a basic configuration of the present invention has a stem 40 provided at the center of a pair of handlebars 20 of a bike for the handlebars 20 to connect to a fork 10 through the stem 40. Wherein, as also illustrated in FIG. 4, the fork 10 related to a hollow tube has at its top fixed with a shaft holder 6, and a shaft 61 is forthwith provided at the top of the shaft holder 60. In the preferred embodiment, the fork 10 contains a tungsten wash 11, a screwed hole 111 is provided at the center of the tungsten washer 11; a plug 73 is provide at the top of the shaft 61; and a bolt 53 penetrates through the plug 73 to engage in the screwed hole 111 to lock the shaft holder 60 to the fork 10.

A sleeve 70 is provided at the tail of the stem 40 to be inserted onto the shaft 61. A flange 83 is provided to the shaft holder 60 to be connected by compression to the lower edge of the sleeve 70. A protrusion 81 is provided at the lower edge of the sleeve 70 and multiple recesses are provided on the flange 83 at where the lower edge of the sleeve 70 meets the flange 83. A suppression ring is screwed to the top of the shaft 61 to restrict the sleeve 70 from engaging in axial movement, and a coil 74 is provided at where between the sleeve 70 and the shaft 61 to push the sleeve 70 against the flange 83.

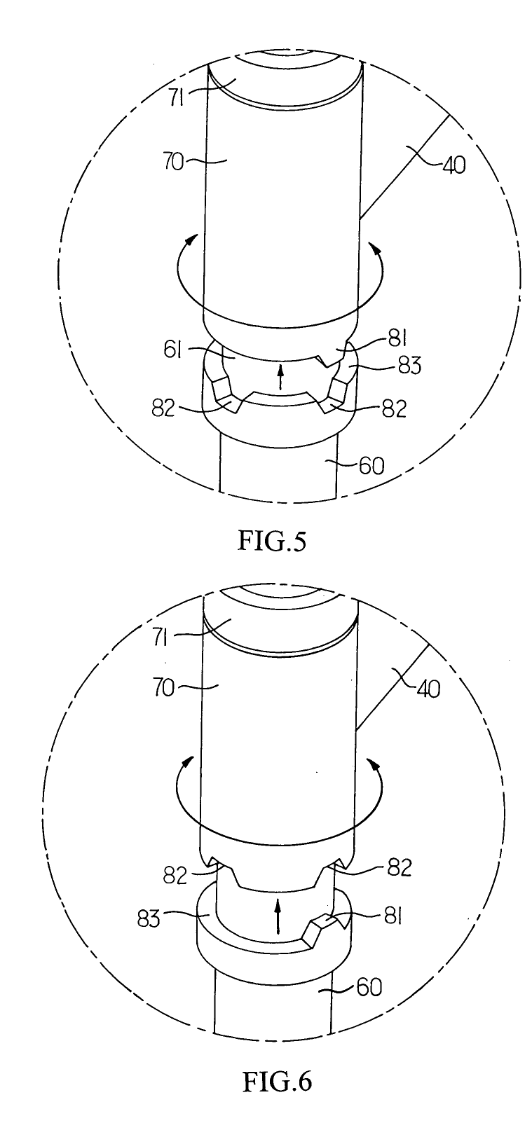

In the preferred embodiment, outer thread 62 is provided at the top of the shaft 61 and inner thread 72 is provided on the inner circumference of the suppression ring 71 to facilitate the adjustment of the suppression from the suppression ring 71 upon the sleeve 70 when both of the inner and the outer threads 72, 62 are engaged. Accordingly, with the suppression ring 71 is loosened up as illustrated in FIG. 5, the sleeve 70 is lifted up to where the protrusion 81 is disengaged from the recess 82. By turning the sleeve 70 to have the protrusion 81 to engage with another recess 82, the purpose of having a precise adjustment of the horizontal angle of the handlebars is achieved. For the first preferred embodiment as illustrated in FIGS. 2 through 5, the protrusion is provided at the lower edge of the sleeve 70, and multiple recesses are disposed on the flange 83 to define the positioning of the angle of the handlebars. Alternatively, as illustrated in FIG. 6, the protrusion is provided on the flange 83 and those multiple recesses are provided at the lower edge of the sleeve to achieve the same purpose of holding the angle of the handlebars in position.

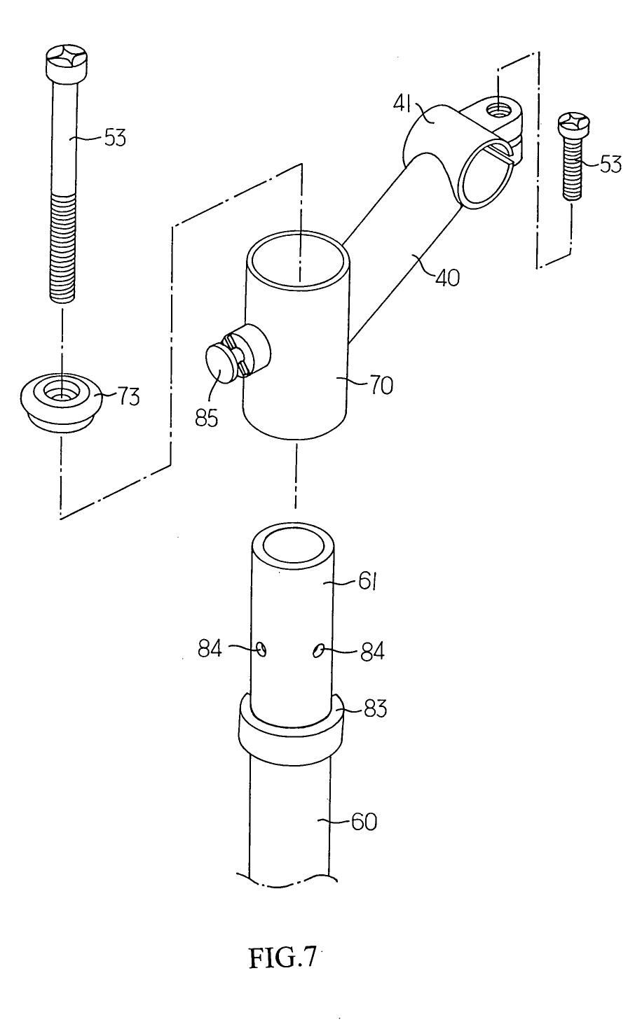

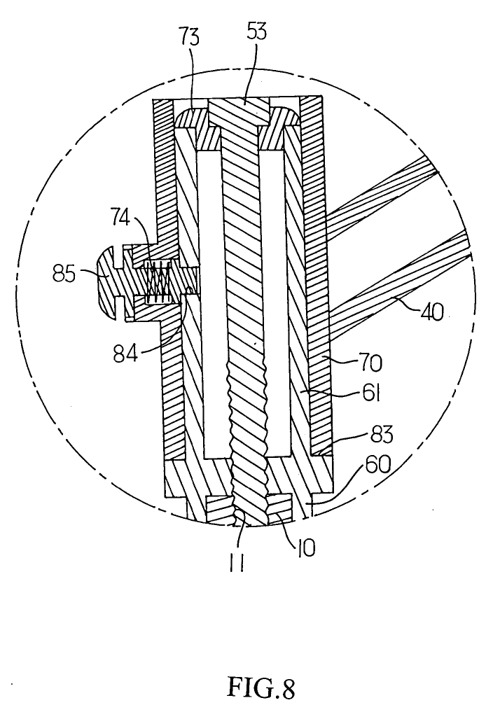

As illustrated in FIGS. 7 and 8, a locking knob 85 is provided to the sleeve 70, and multiple positioning holes 84 are disposed on the shaft 61 at where it is inserted into the sleeve 70. A coil 74 is provided to the sleeve 70 to plunge the locking knob 85 against one positioning hole 84. Accordingly, when the locking knob 85 is pulled out of one positioning hole 84, the sleeve 70 is turned to engage with another positioning hole 84 to achieve the same purpose of having a precise adjustment of the horizontal angle of the handlebars.

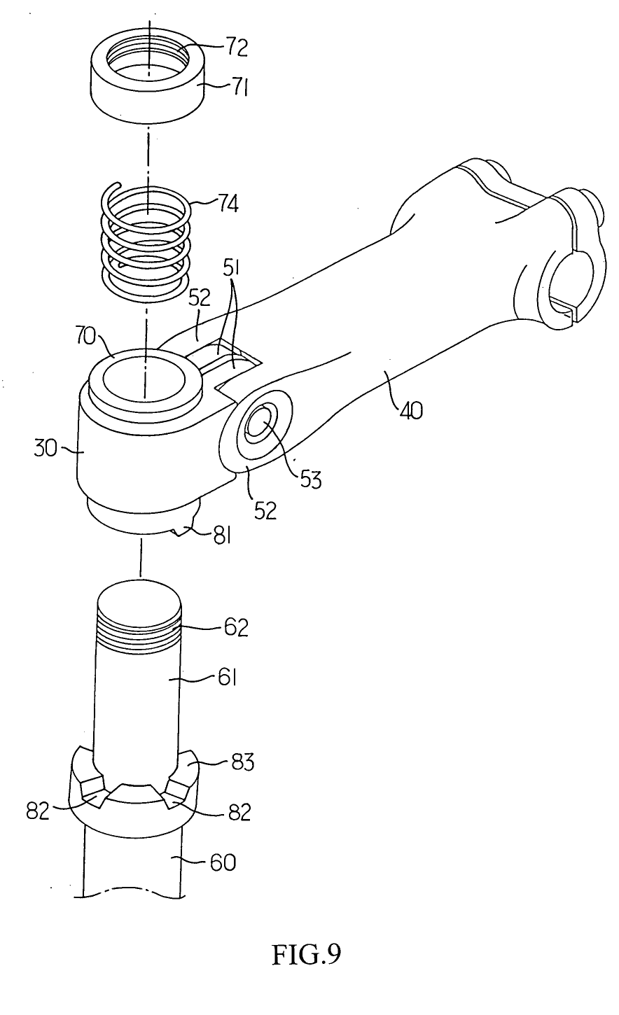

No referring to FIG. 9, a locking head 30 is provided at where between the stem 40 and the sleeve 70. The locking head 30 is related to a brace to clamp the sleeve 70. A pair of pivoting ears extends from both sides of the locking head 30, and a gap extends from where between two pivoting ears to the insertion hole. A pair of clamping ears 52 is provided at the tail of the stem 40 and externally clamps onto both pivoting ears 51. A bolt 53 penetrates through where between both clamping ears 52 and both pivoting ears 51 to constitute the connection between the stem 40 and the locking head 30. With the packing force provided by the bolt 53 is loosened up, a proper travel can be done between both clamping ears 52 and both pivoting ears 51 to provide the function of adjusting the longitudinal angle of the handlebars.

The prevent invention provides an improved construction of an angle adjustment, and this application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

1. A bike handlebars adjustment includes a pair of handlebars connected to a fork through a stem; the fork having at its top fixed with a shaft holder; a shaft being forthwith disposed to the top of the shaft holder; a flange being provided to the shaft holder to connect by compression to the lower edge of the sleeve; the lower edge of the sleeve and the flange being respectively provided with a protrusion and multiple recesses at where the lower edge of the sleeve meets the flange; a suppression ring being screwed to the top of the shaft to restrict axial movement by the sleeve; and a stem, having at its tail disposed with the sleeve to insert onto the shaft; the sleeve being lifted up to where the protrusion is disengaged from one recess; and the sleeve being turned for the protrusion to engage with another recess for achieving the precise adjustment of the horizontal angle of the handlebars.

2. The bike handlebars adjustment of claim 1 wherein the protrusion is provided at the lower edge of the sleeve, and those multiple recesses are disposed on the flange.

3. The bike handlebars adjustment of claim 1 wherein the protrusion is provided on the flange and multiple recesses are provided on the lower edge of the sleeve.

4. The bike handlebars adjustment of claim 1 wherein a coil is provided at where between the sleeve and the shaft to plunge the sleeve against the flange.

5. The bike handlebars adjustment of claim 1 wherein the fork contains a tungsten washer; a screwed hole being provided at the center of the tungsten washer; a plug being inserted to the top of the shaft; a bolt penetrating through the plug to engage into the screwed hole to secure the shaft holder to the fork.

6. A bike handlebars adjustment includes a pair of handlebars connected to a fork through a stem; the fork having fixed at its top a shaft holder; a shaft being forthwith provided to the top of the shaft holder; a flange being provided to the shaft holder to connect by compression to the lower edge of the sleeve; a locking knob and multiple positioning holes being respectively provided to the sleeve and the shaft at where it is inserted into the sleeve; and a coil being provided to the sleeve to plunge the locking knob against one positioning hole; and a stem having provided at its tail the sleeve inserting onto the shaft; the locking knob being pulled out of one positioning hole; and the sleeve being turned for the locking knob to engage with another positioning hole for achieving the precise adjustment of the horizontal angle of the handlebars.

7. The bike handlebars adjustment of claim 6 wherein the fork contains a tungsten washer; a screwed hole being provided at the center of the tungsten washer; a plug being inserted to the top of the shaft; a bolt penetrating through the plug to engage into the screwed hole to secure the shaft holder to the fork.

8. The bike handlebars adjustment of claim 1 wherein a locking head is disposed at where between the stem and the sleeve; the locking head related to a brace to clamp the sleeve; a pair of pivoting ears extending from both sides of the locking head, a gap extending from where between two pivoting ears to the insertion hole; a pair of clamping ears being provided at the tail of the stem and externally clamping onto both pivoting ears; a bolt penetrating through where between both clamping ears and both pivoting ears to constitute the connection between the stem and the locking head; and the packing force provided by the bolt being loosened up to permit a proper travel between both clamping ears and both pivoting ears to adjust the longitudinal angle of the handlebars.

9. The bike handlebars adjustment of claim 6 wherein a locking head is provided between the stem and the sleeve; the locking head related to a brace to clamp the sleeve; a pair of pivoting ears extending from both sides of the locking head, a gap extending from where between two pivoting ears to the insertion hole; a pair of clamping ears being provided at the tail of the stem and externally clamping onto both pivoting ears; a bolt penetrating through where between both clamping ears and both pivoting ears to constitute the connection between the stem and the locking head; and the packing force provided by the bolt being loosened up to permit a proper travel between both clamping ears and both pivoting ears to adjust the longitudinal angle of the handlebars.
